(19) United States
(12) Patent Application Publication
(10) Pub. No.: US 2001/0013236 A1
(43) Pub. Date: Aug. 16, 2001

(54) LOCK FOR A VEHICLE REAR DOOR OR A REAR HATCH PROVIDED WITH A WINDOW WIPER

(76) Inventors: BERND WEYERSTALL, WUPPERTAL (DE); ULRICH BUDDE, BERGNEUSTADT (DE)

Correspondence Address: DAVID S SAFRAN, NIXON PEABODY LLP, 8180 GREENSBORO DRIVE, SUITE 800, MCLEAN, VA, 22102, US

(21) Appl. No.: 09/284,972

(22) PCT Filed: Oct. 30, 1997
(86) PCT No.: PCT/DE97/02531

§ 371 Date: None

(30) Foreign Application Priority Data
Nov. 6, 1996 (DE) 196 45 611.8

(51) Int. Cl. B60R 25/00

(52) U.S. Cl. 70/239

(57) ABSTRACT

The subject matter of the invention is a motor vehicle rear door lock or rear hatch lock with locking components such as a fork latch and detent pawl and with an electrical drive motor (12) which raises the detent pawl optionally via an intermediate lever (5) to open the rear hatch (1), with gearing (13) connected on the output side, for use in a rear hatch (1) with a rear window wiper device (4) with an electrical wiper motor. To achieve higher integration and for simplification it is provided that the wiper motor is used as an electric drive motor (12) and for this reason can be operationally coupled via the gearing (13) to the detent pawl and to the intermediate lever (5).

The invention relates to a motor vehicle rear door lock or rear hatch lock with locking components such as a fork latch and detent pawl and with an electrical drive motor which raises the detent pawl optionally via an intermediate lever to open the rear hatch, with gearing connected on the output side, for use in a rear hatch with a rear window wiper device with an electrical wiper motor.

In rear doors and rear hatches of motor vehicles rear window wiper devices with an electric wiper motor have become the standard in the meantime. On these rear doors and rear hatches there are of course also door locks with locking components which are conventionally a fork latch and a detent pawl. Modifications of the fork latches and the detent pawls in various versions are known from the prior art. Having the detent pawl raised to open the rear hatch proceeding from an electric drive motor with gearing connected on the output side, therefore enabling remote opening of the rear hatch or rear door are also known (DE-A-32 42 527).

The trend in development of motor vehicle bodies is towards further simplification and integration. The problem underlying the invention is therefore further simplification and integration of a generic motor vehicle rear door lock or rear hatch lock.

The aforementioned object is achieved in a motor vehicle rear door lock or rear hatch lock by the wiper motor of the rear window wiper device being used as a drive motor of the locking means and for this purpose its having an operational coupling capacity via the gearing to the detent pawl.

Because the wiper motor of the existing rear window wiper device is used as the drive motor of the locking device, an additional drive motor can be abandoned in the locking means itself. A motorized opening aid for the motor vehicle rear door lock or rear hatch lock can be easily effected, specifically by a minor modification of the rear window wiper device in the area of the electric wiper motor. It is then simply a question of electrical control of the wiper motor how the above explained functions are accomplished in the system.

The prior art discloses a secondary use for a wiper motor or a rear window wiper device (DE-C-38 07 087). It is provided in this prior art that the wiper motor of an existing rear window wiper device be used as the auxiliary motor of a tightening means of a motor vehicle rear hatch lock. Differently than in the teaching of this invention therefore here the secondary use of the wiper motor is to pull the rear hatch of a motor vehicle out of the preliminary catch -position into the main catch position as is explained in the further prior art (DE-A-34 09 996). There is no motorized opening aid in this prior art nor can one be integrated.

Especially preferred embodiments and developments of the teaching of the invention are the subject matter of the dependent claims. Here claim 2 acquires special importance; it is directed at combining, therefore integrating the rear window wiper device with the rear window lock itself into one module. This makes it possible to integrate the entire arrangement in one pass in the rear hatch or the rear door. The yield major advantages in terms of assembly technology and thus economy.

In the following the invention is detailed using drawings which show simply embodiments,

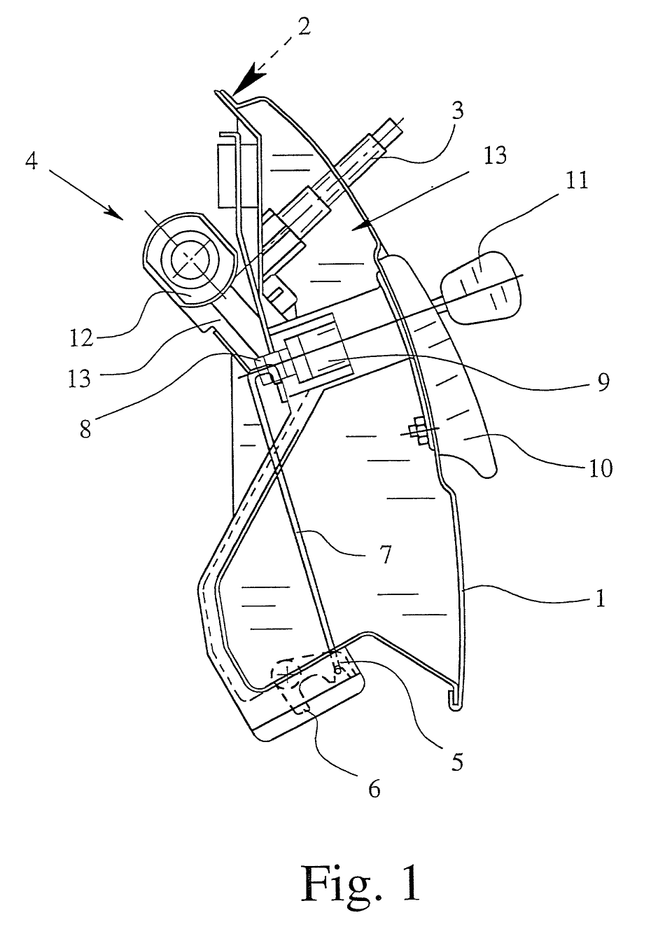

FIG. 1 shows by way of an extract in a cross section a rear hatch of a motor vehicle with an integrated rear window wiper device, a locking cylinder with a key, door handle, and rear hatch lock,

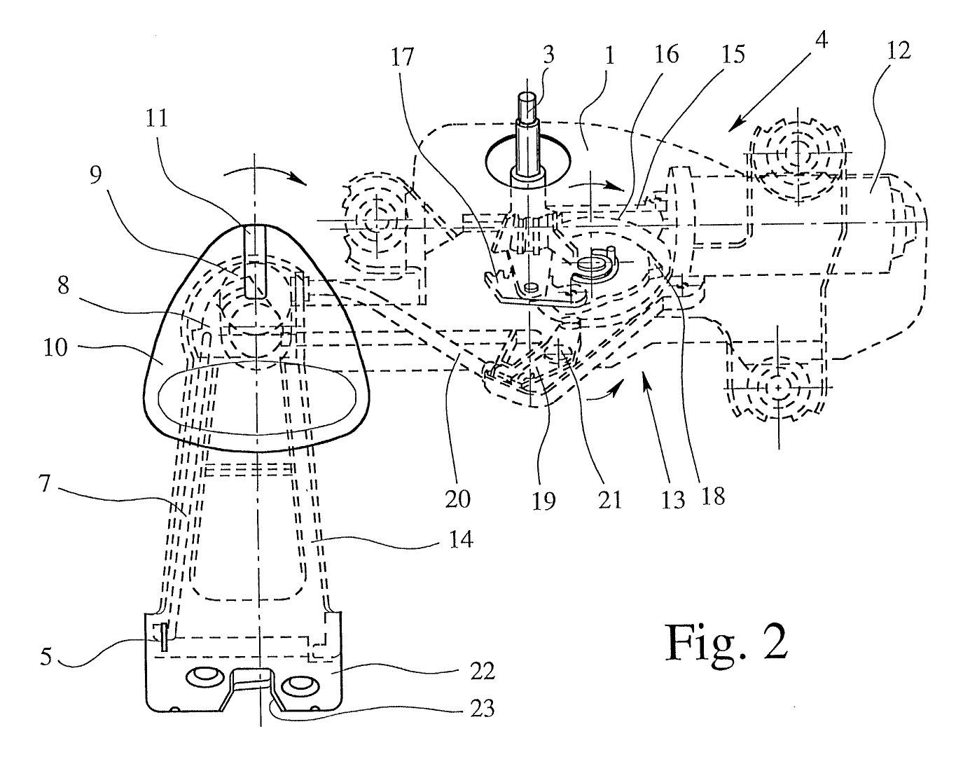

FIG. 2 shows an integrated module consisting of a rear window wiper device and rear hatch lock with a motorized opening aid according to FIG. 1,

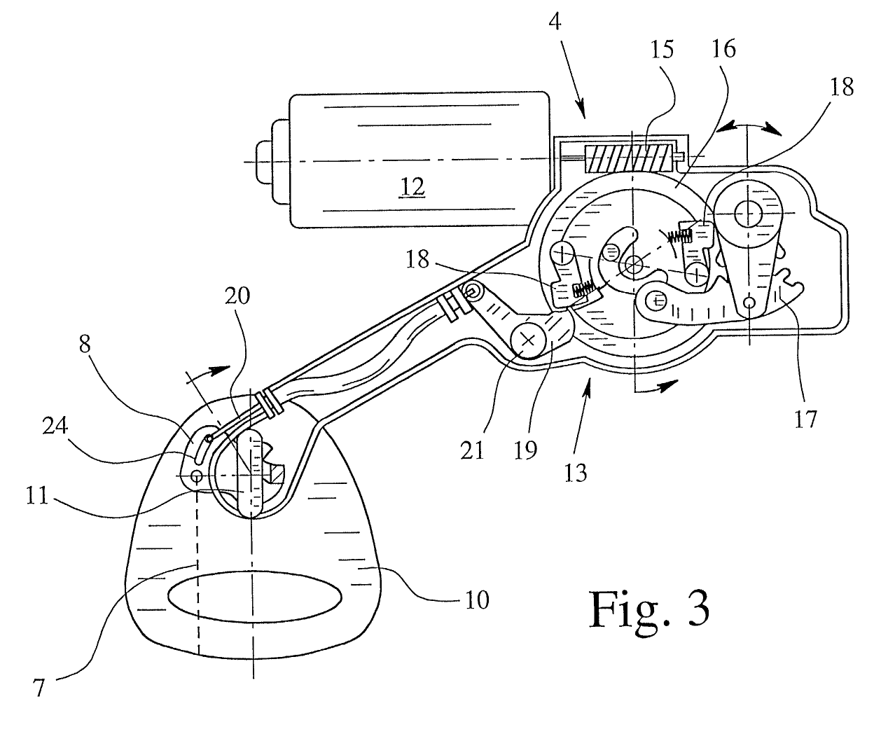

FIG. 3 shows a second embodiment of the teaching of the invention.

FIGS. 1 and 2 should be examined in combination in order to correctly understand the teaching of the invention.

A motor vehicle rear hatch lock is shown in which the term rear hatch can also describe the rear door of a station wagon. This embodiment shows the rear hatch 1 of a compact motor vehicle, specifically the lower area which is adjoined to the top in the corresponding oblique position by a rear window 2, indicated in FIG. 1. Generally an opening is machined into the rear hatch 1 or in alternative embodiments also into the rear window 2 itself and a drive pin 3 projects through the opening for the wiper arm of a rear window wiper device 4, the arm not being shown here.

The conventional locking elements of the motor vehicle rear hatch lock such as a fork latch or a detent pawl are not shown. In this regard reference should be made to the prior art, for example DE-A-34 09 996, or the publication mentioned initially.

To open the rear hatch 1 the detent pawl of the motor vehicle rear hatch lock is raised, often via an intermediate level 5, so that the fork latch can swivel out and can release the locking hinge on the body frame. FIG. 1 in this respect shows the intermediate lever 5 which via an actuating arm 6 raises the detent pawl of the motor vehicle rear hatch lock which cannot be recognized here and is actuated itself by an actuating rod 7 which is suspended on a crank 8 on a locking cylinder 9 of the rear hatch lock. Externally on the rear hatch 1 an outside handle 10 is apparent into which the insertion opening of the locking cylinder 9 is integrated; the door key 11 inserted there can be seen. By turning the locking cylinder 9 by means of the door key 1 the crank 8 can be turned, the actuating rod 7 pulled and the intermediate lever 5 raised so that the detent pawl is raised via the actuating arm 6. The rear hatch 1 can be opened by means of the outside handle 10.

The motor vehicle rear hatch lock which is shown here however also includes an electric drive motor 12 which is used for purposes of remote opening of the rear hatch 1, with gearing 13 which is connected on the output side and which likewise raises the detent pawl, here again via the intermediate lever 5, to open the rear hatch 1.

At this point it is significant to the invention that the wiper motor of the rear window wiper device 4 is used as an electric drive motor 12 and for this reason can be operationally coupled via the gearing 13 to the detent pawl or the intermediate lever 5. This has the advantages of a higher degree of integration, simpler structure and lower costs which are described in the general part of the specification.

FIG. 2, left, shows an attachment bracket 14 for the locking cylinder 9 on the rear hatch 1. In it in turn on the left is the actuating rod 7 which is suspended underneath on the intermediate lever 5 and overhead in the crank 8. The locking cylinder 9 and the door lock 11 are shown. FIG. 2, right, shows the electric drive motor 12 which is coupled to gearing 13 made as a worm gear pair, with a worm 15 and a worm gear 16. Rotation of the worm gear 16 counterclockwise, as indicated by the arrow underneath, corresponds to wiper operation via a toothed catch 17 to the drive pin 3. Rotation of the worm gear 16 clockwise, as indicated by the arrow at the top, performs the opening aid function via a spring loaded driver 18. In this regard, in the embodiment shown there is a twin-arm actuating lever 19 which interact with the driver 18 and which is coupled via a Bowden cable 20 to the crank 8. When the worm gear 16 turns clockwise the leading edge of the driver 18 meets the outer end of the actuating lever 19 and swivels it counterclockwise in FIG. 2 around the swivel axis 21. In this way the Bowden cable 20 is pulled, the crank 8 in FIG. 2 is turned clockwise and is raised via the actuating rod 7 of the intermediate lever 5, therefore the detent pawl is raised.

If the worm gear 16 turns in the opposite direction, therefore counterclockwise, the spring-loaded driver 18 snaps past the front end of the actuating lever 19 without moving it further.

For the embodiment shown it is furthermore important that the rear window wiper device 4 is integrated with the rear hatch lock into a module. This is shown very clearly in FIG. 2, specifically the attachment points for the overall arrangement. Otherwise, here in a special version the motor vehicle door lock 22 itself is integrated in the attachment bracket 14, recognizable with the inlet slot 23 for the lock hinge.

FIG. 2 further shows that the detent pawl and the intermediate lever 5 via a rod assembly—actuating rod 7—and/or via a Bowden cable—Bowden cable 20—is connected to the gearing 13. The actual motor vehicle door lock 22 with the detent pawl is located therefore spatially distant from the drive motor 12. Of course in alternative versions it can also be located directly on the electric drive motor 12, which depends on the overall structural form of the rear hatch 1.

As has been explained above, it applies to the embodiment shown that the electric drive motor 12 can be triggered in both directions of rotation and the gearing 13 in one direction of rotation closes the power transmission train to the wiper device 4 and in the other direction of rotation the power transmission train to the detent pawl and to the intermediate lever 5. This was explained in detail above.

FIG. 3 shows the embodiment again somewhat modified in its arrangement, but otherwise very similar in structure. Here the opening direction is the direction of rotation of the worm gear 16 counterclockwise, the wiper direction is the direction of rotation of the worm gear 16 clockwise. Otherwise here there are two drivers, spring-loaded.

One alternative not shown in the drawings consists in that the drive motor 12 can be triggered in one direction of rotation, but at two speeds of rotation, and the gearing at one speed of rotation, preferably at lower rpm, closes the power transmission train to the wiper device 4, while at the other speed of rotation, preferably higher rpm, it closes the power transmission train to the detent pawl or to the intermediate lever 5. This function can be accomplished via a centrifugal clutch in the gearing 13. The function is such that short, prompt starting of the electric drive motor 12 activates the opening aid, while the normal slow starting of the drive motor 12 activates the wiper device 4.

It was explained initially in the prior art that combined use of the electric drive motor of the rear window wiper device is accomplished there for the wiper device itself and a tightening aid of a motor vehicle rear hatch lock. With the approach as claimed in the invention a triple function of the electric drive motor can be accomplished. If specifically it is provided that the drive motor 12 can be triggered in both directions of rotation and in one direction of rotation at two speeds of rotation, the original wiper function, the opening aid function and the tightening aid function can be combined with one another. To do this it can be provided that the drive motor in one direction of rotation closes the power transmission train to the wiper device and in the other direction of rotation the power transmission train to the tightening aid and that in the direction of rotation which closes the power transmission train to the wiper device a second higher speed of rotation closes the power transmission train to the opening aid.

The preferred embodiment which is illustrated finally shows again that an idle stroke means coupled to the locking cylinder 9 is inserted into the power transmission train to the detent pawl or to the intermediate lever 5, specifically here in the form of an elongated hole 24 in the crank 8 which allows the mechanical lifting of the detent pawl which proceeds from the locking cylinder 9 using the idle stroke, without a motorized function being initiated. This is clearly indicated in FIG. 3. If there the locking cylinder 9 is turned to the right by the door key 11, the crank 8 likewise moves to the right, therefore clockwise, lifts the actuating rod 7 and trips the detent pawl. The Bowden cable 20 to the actuating lever 19 is not touched in doing so.

1. Motor vehicle rear door lock or rear hatch lock with locking components such as a fork latch and detent pawl and with an electrical drive motor (12) which raises the detent pawl optionally via an intermediate lever (5) to open the rear hatch (1), with gearing (13) connected on the output side, for use in a rear hatch (1) with a rear window wiper device (4) with an electric wiper motor, the wiper motor being used as an electric drive motor (12) and for this reason it can be operationally coupled via the gearing (13) to the detent pawl and the intermediate lever (5), characterized in that the rear window wiper device (4) is integrated with the rear hatch lock into a module, that the drive motor (12) can be triggered in two directions of rotation and the gearing (13) in one direction of rotation closes the power transmission train to the wiper device (4), and in the other direction of rotation closes the power transmission train to the detent pawl or to the intermediate lever (5).

2. Motor vehicle rear door lock or rear hatch lock with locking components such as a fork latch and detent pawl and with an electrical drive motor (12) which raises the detent pawl optionally via an intermediate lever (5) to open the rear hatch (1) with gearing (13) connected on the output side, for use in a rear hatch (1) with a rear window wiper device (4) with an electrical wiper motor, the wiper motor being used as an electric drive motor (12) and for this reason can be operationally coupled via the gearing (13) to the detent pawl or the intermediate lever (5), wherein the rear window wiper device (4) is integrated with the rear hatch lock into a module, wherein the drive motor (12) can be triggered in one direction of rotation, but at two speeds of rotation, and the gearing (13) at one speed of rotation, preferably at lower rpm, closes the power transmission train to the wiper device (4), and at the other speed of rotation, preferably higher rpm, it closes the power transmission train to the detent pawl or to the intermediate lever (5).

3. Motor vehicle rear hatch lock as claimed in claim 2, wherein the drive motor (12) can be triggered in two directions of rotation and in one of the directions of rotation at two speeds of rotation, and the gearing in one direction of rotation at one, preferably lower speed of rotation, closes the power transmission train to the wiper device (4), and at the other, preferably higher speed of rotation, it closes the power transmission train to the detent pawl or to the intermediate lever (5), and in the other direction of rotation closes the power transmission train to a tightening aid of the motor vehicle rear hatch lock.

4. Motor vehicle rear hatch lock as claimed in one of claims 1 to 3, wherein the detent pawl or the intermediate lever (5) is connected via a rod assembly (7) and/or a Bowden cable (20) to the gearing (13).

5. Motor vehicle rear hatch lock as claimed in one of claims 1 to 4, wherein an idle stroke means coupled to the locking cylinder (9) is inserted into the power transmission train to the detent pawl or to the intermediate lever (5), and allows mechanical lifting of the detent pawl which proceeds from the locking cylinder (9) using the idle stroke.
